(19) United States
(12) Patent Application Publication
(10) Pub. No.: US 2016/0042363 A1
(43) Pub. Date: Feb. 11, 2016

(54) PUBLIC DATA TO PROFESSIONAL CLIENT MATCHING

(71) Applicant: Jared W. Pierce, Franklinton, NC (US)

(72) Inventor: Jared W. Pierce, Franklinton, NC (US)

(21) Appl. No.: 14/453,064

(22) Filed: Aug. 6, 2014

(51) Int. Cl. G06Q 30/02; G06Q 50/18

(52) U.S. Cl. CPC G06Q 30/0201; G06Q 50/18

(57) ABSTRACT

The present invention relates to a web service/site wherein the site searches the public database for individuals involved in events that would require the services of a professional, such as a lawyer. The site matches individuals in the public database with the professional's clients so that the professional can offer help to the individuals before the individual reaches out to find a professional.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to a method for delivery of public events information. Specifically, it relates to computer systems for mining public data related to events of a first person (such as a client of a professional), so that a second person (such as an individual, a professional, a business, a group, or the like) can contact the first person to provide services or products related.

2. Description of Related Art

The general rules for lawyers and many other professionals, such as doctors, are that unless someone is already a client (patient), there are restrictions on contacting a potential client. While general advertising is acceptable, cold call type contact is not acceptable.

Typically, professionals rely on the client contacting the professional when additional services are needed. However, frequently clients will search out new lawyers or the like when a new event occurs. Frequently, the type of events that would need a professional are recorded in public databases. For example: accident records, arrest records, valuation, purchases and sales (of, for example, a business or a piece of property).

Other types of persons can also have need to know public information about individuals for the purpose of selling/giving services and products to the underserved. For example, web-sites such as Facebook or other similar web-sites are inefficient at advertising services or products to an individual when they use the site. Without knowledge of the public data, advertising directly to the client based on information gathered from a public database is not possible and is limited.

This information changes literally by the minute, and searching these public records could be profitable, but is in no way practical. Some data is available on online sites. For example, a home owner or potential home owner can use web-sites to search the public data about a particular piece of property. There is currently no system for matching selling services and products with individuals having public data published.

### BRIEF SUMMARY OF THE INVENTION

The present invention relates to the discovery of a system and method whereby a person (described here as a user) can access a web-site, and in that system can compare the user's clients, visitors, etc. (hereinafter “individual”) to a list of public data about that client, visitor, or the like, and report that comparison to the user. This way the user can generate more business with that individual than if the user had waited for the individual to contact the user.

Accordingly, in one embodiment there is a system for a professional to aid their clients comprising:
a) a web-site connected to an internet;
b) one or more server hosting the web-site having associated therewith a computer readable memory;
c) a list of identification information of the professional's clients uploaded into the computer readable memory;
d) a set of instructions in the computer readable memory for searching the public records for identification information about individuals in the public record;
e) a set of instructions in the computer readable memory for matching the client's identification information with the public record individual's identification information; and
f) a set of instructions within the computer readable memory for reporting the matches to the professional user.

In another embodiment, there is a method of providing the professional user with updated activity information about their clients comprising:
a) creating a web-site hosted on one or more servers, having a computer readable memory associated therewith and connected to the internet the web-site comprising:
   i. a set of instructions in the computer readable memory for searching the public records for identification information about individuals in the public record;
   ii. a set of instructions in the computer readable memory for matching the client identification information with the public record individual's identification information; and
   iii. a set of instructions within the computer readable memory for reporting the matches to the client;
b) a user creating an account on the web-site;
c) the user uploading a list of their client's identification information to the computer readable memory of the one or more web-site servers;
d) the one or more servers searching the public records for the individual's identification information; and
e) the server matching the client identification information with the public record identification information and reporting the matches to the professional user.

A system for a user to provide a service or product to a user comprising:
a) a web-site connected to an internet;
b) one or more servers hosting the web-site having associated therewith a computer readable memory;
c) a list of identification information of the user's individuals uploaded into the computer readable memory;
d) a set of instructions in the computer readable memory for searching the public records for identification information about individuals in the public record;
e) a set of instructions in the computer readable memory for matching the individual's identification information with the public record individual's identification information; and
f) a set of instructions within the computer readable memory for reporting the matches to the user.

A system according to the above wherein the person is a social network.

A method of providing a user with updated activity information about the individual comprising:
a) creating a web-site hosted on one or more servers, having a computer readable memory associated therewith and connected to the internet the web-site comprising:
   i. a set of instructions in the computer readable memory for searching the public records for identification information about individuals in the public record;
   ii. a set of instructions in the computer readable memory for matching the individual's identification information with the public record individual's identification information; and
   iii. a set of instructions within the computer readable memory for reporting the matches to the user;
b) a user creating an account on the web-site;
c) the user uploading a list of their client's identification information to the computer readable memory of the one or more web-site servers;
d) the one or more servers searching the public records for individual's identification information; and
e) the server matching the individual's identification information with the public record identification information and reporting the matches to the user.

A method according to the above wherein the user is a social network.

### BRIEF DESCRIPTION OF THE DRAWINGS

FIG. 1 is a relationship chart of the system of the present invention.

FIG. 2 is a flow chart of the method of the present invention.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

### DEFINITIONS

The terms “about” and “essentially” mean ±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein, the term “individual” refers to any person for whom there is public data available. As used herein the term “person” or “user” refers to a human individual, a corporation, a company, a group, or the like. The user in one embodiment is in possession of identifiable information taken from their own databases, accounts or lists generally kept in the general course of business. “Public data” is any public accumulation of data that chronicles an event involving individuals—e.g. accidents, arrest records, incorporations, purchases, moving violation, and the like. In general, public records are government records, but in another embodiment they are from any source.

As used herein the term “professional” refers to a person working in an area that requires specialized knowledge, education and training. In one embodiment it refers to those individuals who must have a college degree and pass a licensure exam for working in a particular trade. In one further embodiment, it refers to a licensed lawyer. A licensed lawyer can be any type of lawyer whose clients may do something in the public record that would mean further work from the lawyer was needed. Such “public records” would include criminal offense records, accident records and motor vehicle ticket records.

As used herein the term “web-site” refers as used in this document to a logical location (e.g., an Internet or intranet location) identified by a URL, or it refers to a web server hosting the web-site represented by the URL. For example, some “web-sites” are distributed over multiple Internet or network locations, but have a shared web server(s) hosting those locations, and in many situations it is logical to consider those network locations to all be part of “a web-site.” Web-sites can be open or require a password to all or part of the web-site. The web-site will normally have a cost associated with access to the web-site and or the services provided at the web-site.

As used herein, the term “user interface” describes any device, app, GUI or group of devices for presenting and/or receiving information and/or directions to and/or from the web-site. A user interface may comprise a means to present information to persons, such as a visual display projector or screen, chat, a Braille device, a vibrating device, or the like. A user interface may also include a means to receive information or directions from the web-site (from other users and the web-site), such as one or more or combinations of buttons, keys, levers, switches, knobs, touch pads, touch screens, microphones, speech detectors, motion detectors, cameras, and light detectors. Exemplary user interfaces comprise web pages, mobile phones, laptop computers, handheld and smart computers, personal digital assistants (PDAs), keyboards, keypads, liquid crystal displays (LCDs), control panels, and speech recognition devices.

As used herein, the term “associating” or “associated” refers to including direct and/or indirect coupling of separate items and/or one item being embedded within another item. The association provides a desired relationship between the items being associated. For example, where a web-site is associated with the system of the present invention, it is usable by web-site users e.g. professionals or other users, who are accessing (and being associated with) the web-site.

As used herein the term “access” refers to the system allowing the plurality of users to view and use the web-site and the communication system thereon. The users may have to pay a fee, sign in, create a password and or an account, fill in user information and the like to gain access to the web-site, either by using an app to access the web-site or signing in the web-site using the URL or the like. One skilled in the art understands how one can access a web-site and how that could be limited so that only desired users can access it. One can easily have users register for a live event or use GPS to know they are at a live event or the like and grant access to those others at the live event.

As used herein the term “clients” refers to individuals who are customers of a professional and who have sought out the professional services of the professional. So, for example, the customers have previously been clients of a lawyer such as a general lawyer, an accident lawyer and the like.

As used herein, the term “Internet” refers to a collection of interconnected (public and/or private) networks that are linked together by a set of standard protocols (such as TCP/IP and HTTP) to form a global, distributed network. While this term is intended to refer to what is now commonly known as the Internet, it is also intended to encompass variations which may be made in the future, including changes and additions to existing standard protocols.

As used herein, the terms “World Wide Web” or “web” refer generally to both (i) a distributed collection of interlinked, user-viewable hypertext documents (commonly referred to as Web documents or Web pages) that are accessible via the Internet, and (ii) the client and server software components which provide user access to such documents using standardized Internet protocols. Currently, the primary standard protocol for allowing applications to locate and acquire Web documents is HTTP, and the Web pages are encoded using HTML. However, the terms “Web” and “World Wide Web” are intended to encompass future markup languages and transport protocols which may be used in place of (or in addition to) HTML and HTTP.

As used herein, the term “server” refers to a computer that is responsible for accepting requests from clients, which are known as “web browsers,” and serving them responses along with optional data contents, which usually are web pages such as HTML documents and linked objects (images, etc.) or other files. There may be several intermediaries, such as proxies, gateways, and tunnels between the HTTP client and HTTP server. A server typically includes hardware, operating system, server software (IIS, Apache, etc.) that manages requests from the browser and delivers web pages (HTML documents and files) in response, FTP server software for file downloads, SMTP server software for e-mail service, and site content (e.g., web pages and other files). A server also executes server-side scripts (CGI scripts, JSPs, ASPs, etc.). If the server is used internally and not by the public, it may be called an “intranet server.”

The term “computer-readable memory” refers to any man-made data storage device readable by a computer, whether volatile or non-volatile or implemented electronically or otherwise, known in the art, including floppy disks, hard disks, CD-ROMs, DVDs, flash memories, nonvolatile ROMs, and RAMS. “Communicatively connected” refers to any manner of data communication between devices known in the art, whether wired or wireless.

As used herein the term “client identification information” or “individual identification information” relates to any one or more pieces of information relating to identifying an individual such as a client of the professional. Included, but not limiting, are first name, last name, date of birth, race, address (home or work), city, state, case number(s), aliases, charges, vehicle type, insurance and the like. This information can be used to match public data information, i.e. the same information released by public record sites such as DUI sites, crime activity sites or any public site reporting an event, to an event that may be used to sell/give the individual a product or service. This information, in one embodiment, is Hipaa compliant information.

As used herein, the term “set of instructions” refers to programming in the server or associated computer(s) which can cause the computer, via the internet or the like, to scan the public record for individual's identification information (the same data as client identification information) and match the data. Matches do not need to be identical, just match one or more of the pieces of information so that the professional user can decide if the match is their individual client. For example, if only the last names match, it may or may not be a match, but could be reported as a possible match. Therefore, matches include 100% matches as well as possible matches that only match some of the identification information. The server then takes the identified matches and reports the matches to the professional user by any means. Mail, e-mail, Instant messaging, texting, a report page(s) on the web-site and the like can all be used as desired by the professional to report the matches. Likewise, the frequency is within the skill in the art, as well as how close a match is delivered. The frequency could be every time there is a match, or searching can be done weekly, monthly, or the like. The set of instructions in one embodiment can be electable so that, for example, only DUI records are searched, or only arrest records are searched.

The system of the present invention can also have further embodiments. For example, there could be data tracking of past events or a reporting system that delivers information in a desired report format. Such reporting systems are within the skill in the art.

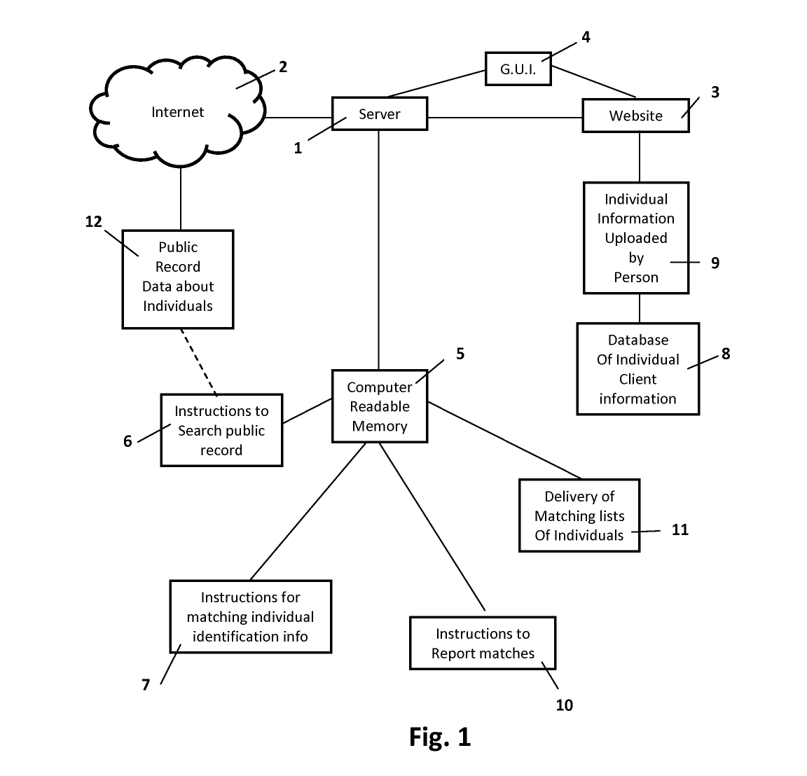

Now, referring to the drawings, FIG. 1 is a graphic representation of the system of the present invention. A server 1 is connected to the internet 2. The server 1 hosts a web-site 3 so that access by a user to the web-site 3 is done through the internet 2 and optionally using a Graphic User Interface (GUI) 4. The server 1 has associated therewith a computer readable memory 5. The computer readable memory 5 has in memory instructions 6 for searching the public record of an individual 12, instructions for matching individual's information 7 wherein the individual's information is obtained from a database of individual's information 8 which is provided by the person/user 9 through the website 3. The computer readable memory 5 also has instructions for reporting the matches 10 and then delivering of the matches 11 via the website 3.

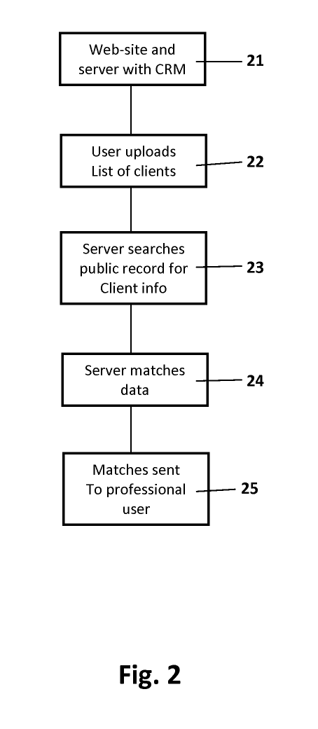

FIG. 2 depicts a flow chart of the method of the present invention. A web-site hosted on a server is established with a computer readable memory 21. The computer readable memory is populated with a list of individual's such as a professional's clients 22 via uploading information about the individual (as described above). The server then searches the public record (via the internet) for individual's information 23. The server then matches the two lists 24 to determine which of the public data relates to the list of individuals. The matches are then sent to the user for their use 25.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials and the like apparent to those skilled in the art still fall within the scope of the invention as claimed by the applicant.

What is claimed is:

1. A system for a professional to aid their clients comprising:
a) a web-site connected to an internet;
b) one or more servers hosting the web-site having associated therewith a computer readable memory;
c) a list of identification information of the professional's clients uploaded into the computer readable memory;
d) a set of instructions in the computer readable memory for searching the public records for identification information about individuals in the public record;
e) a set of instructions in the computer readable memory for matching the client's identification information with the public record individual's identification information; and
f) a set of instructions within the computer readable memory for reporting the matches to the client.

2. The system according to claim 1 wherein the public records are at least one of the list comprising criminal offense records, accident records, and motor vehicle ticket records.

3. The system according to claim 1 wherein the reporting in the system is done by at least one of email or texting.

4. The system according to claim 1 wherein the reporting in the system is done by delivering a reporting page on the web-site.

5. The system according to claim 1 wherein the area that the public records search is selectable or uploadable.

6. The system according to claim 1 wherein the professional creates an account in the system for the purpose of utilizing the system.

7. The system according to claim 1 wherein the reporting is done essentially every day that there is a new data entry in the public record.

8. The system according to claim 1 which further comprises a data tracking and reporting system.

9. The system according to claim 1 wherein all data is stored in a database on the one or more server.

10. The system according to claim 1 wherein the professional is a licensed lawyer.

11. The system according to claim 1 wherein there is a graphic user interface for accessing the website.

12. A method of providing a professional user with updated activity information about their clients comprising:
a) creating a web-site hosted on one or more servers, having a computer readable memory associated therewith and connected to the internet the web-site comprising:
i. a set of instructions in the computer readable memory for searching the public records for identification information about individuals in the public record;
ii. a set of instructions in the computer readable memory for matching the client identification information with the public record individual's identification information; and
iii. a set of instructions within the computer readable memory for reporting the matches to the professional;
b) a user creating an account on the web-site;
c) the user uploading a list of their client's identification information to the computer readable memory of the one or more web-site servers;
d) the one or more servers searching the public records for individual's identification information; and
e) the server matching the client identification information with the public record identification information and reporting the matches to the professional user.

13. The method according to claim 12 wherein the public records are at least one of the list comprising criminal offense records, accident records, motor vehicle ticket records

14. The method according to claim 12 wherein the reporting in the system is done by at least one of email or texting.

15. The method according to claim 12 wherein the reporting in the system is done by delivering a reporting page on the web-site.

16. The method according to claim 12 wherein the area that the public records search is selectable or uploadable.

17. The method according to claim 12 wherein the professional user creates an account in the system for the purpose of utilizing the system.

18. The method according to claim 12 wherein the reporting is done essentially every day there is a new data entry in the public record.

19. The method according to claim 12 which further comprises a data tracking and reporting system.

20. The method according to claim 12 wherein all data is stored in a database on the one or more server.

21. A system for a providing a service or product to an user comprising;
a) a web-site connected to an internet;
b) one or more servers hosting the web-site having associated therewith a computer readable memory;
c) a list of identification information of the user's individuals uploaded into the computer readable memory;
d) a set of instructions in the computer readable memory for searching the public records for identification information about individuals in the public record;
e) a set of instructions in the computer readable memory for matching the individual's identification information with the public record individual's identification information; and
f) a set of instructions within the computer readable memory for reporting the matches to the user.

22. A system according to claim 21 wherein the user is a in possession of identifiable information taken from their own databases, accounts or lists generally kept in the general course of business.

23. A method of providing the user with updated activity information about individuals comprising:
a) creating a web-site hosted on one or more servers, having a computer readable memory associated therewith and connected to the internet the web-site comprising:
i. a set of instructions in the computer readable memory for searching the public records for identification information about individuals in the public record;
ii. a set of instructions in the computer readable memory for matching the individual identification information with the public record individual's identification information; and
iii. a set of instructions within the computer readable memory for reporting the matches to the user;
b) a user creating an account on the web-site;
c) the user uploading a list of the individual's identification information to the computer readable memory of the one or more web-site servers;
d) the one or more servers searching the public records for individual's identification information; and
e) the server matching the individual's identification information with the public record identification information and reporting the matches to the user.

24. A method according to claim 23 wherein the user is a in possession of identifiable information taken from their own databases, accounts or lists generally kept in the general course of business.
